(19) United States
(12) Patent Application Publication
(10) Pub. No.: US 2026/0220633 A1
(43) Pub. Date: Jul. 30, 2026

(54) ELECTRONIC COMMERCE AUTHORIZATION SYSTEM, ELECTRONIC COMMERCE MANAGEMENT SYSTEM, AUTHORIZATION METHOD FOR ELECTRONIC COMMERCE, AND ELECTRONIC COMMERCE METHOD

(71) Applicant: Vlightup Inc., Tokyo (JP)

(72) Inventor: Sachio MINAMOTO, Tokyo (JP)

(73) Assignee: Vlightup Inc., Tokyo (JP)

(21) Appl. No.: 19/144,363

(22) PCT Filed: Dec. 28, 2023
(86) PCT No.: PCT/JP2023/047263

§ 371 Date: Jun. 27, 2025

(30) Foreign Application Priority Data
Dec. 29, 2022 (JP) 2022212844

(51) Int. Cl. G06Q 20/40

(52) U.S. Cl. CPC G06Q 20/401

(57) ABSTRACT

The present disclosure provides an electronic commerce approval system which is used for fair trade, authentic transactions and highly reliable transactions in electronic commerce using the crypto-assets by approving electronic commerce based on the location or activity range of a supplier and a client. The approval server 30 is a device functioning as an electronic commerce approval system, and is configured to: manage reference information on activity location and scope indicating a location or scope of an activity for references serving as the reference of activity of target user for each user who becomes a supplier or a client; determine the authenticity of the supplier or the client by using activity location and scope information when executing the process relating to the electronic commerce as an electronic commerce based on supplier or a client; and execute an approval process of approving the electronic commerce.

### TECHNICAL FIELD TECHNICAL FIELD

The present invention relates to an electronic commerce approval system, an electronic commerce management system, an approval method of electronic commerce, an electronic commerce method, and the like.

### BACKGROUND ART

In recent years, illegal use represented by so-called spoofing has been increasing rapidly in services such as Internet banking services and online stores via the world wide web (WWW).

Further, in recent years, the development of blockchain technology has not only increased the popularity of crypto-assets such as bitcoin as investment targets and speculation targets but also increased the use of such crypto-assets in commercial transactions such as electronic commerce in place of the legal tender.

However, in recent years, the use of crypto-assets has become a hotbed of money-laundering and illegal transactions, and therefore, in the electronic commerce (e-commerce) based on the crypto-assets, a commercial transaction method that registering the address of the recipient of the crypto-assets is required (for example, the Japan Virtual and Crypto assets Exchange Association, “Notice on Correspondence to Travel Rules in Self-Regulatory Rule determined by the Association”, [online], Mar. 1, 2022 [retrieved on Dec. 20, 2022], Internet <https://jvcea.or.jp/news/main-info/20220301-001/>).

### SUMMARY OF THE INVENTION

### Problem to be Solved by the Invention

However, with the method of the commercial transactions described in the “Notice on Correspondence to Travel Rules in Self-Regulatory Rule determined by the Association”, it is difficult to prevent the money-laundering or the illegal transactions when the sender or receiver of the crypto-assets is an illegal user, even if the address of the receiver of the crypto-assets is registered.

The present invention provides an electronic commerce approval system which is used to fair trade, authentic transactions and highly reliable transactions in electronic commerce (e-commerce) using the crypto-assets by approving electronic commerce based on the location or the scope of activity of a supplier and a client.

### Solution to the Problem

An electronic commerce approval system according to the first aspect of the present invention, for approving a given electronic commerce based on a crypto-asset when the electronic commerce is executed by a supplier and a client, the system has:
a management unit for managing activity location and scope information which is information registered in advance in a storage unit, and which indicates a location or scope of an activity, serving as a reference for an activity of each user who is a supplier or a client;
an identifying unit for identifying a transaction target person based on transaction target person information relating to at least one of the supplier and the client, the transaction target person information being transmitted from a server when the electronic commerce between the supplier and the client is executed by the server;
an approval process unit for executing an approval process of approving the electronic commerce between the identified supplier and the client;
a providing unit that provides the result of the approval process to the server, wherein
the approval process unit performs the approval process:
   executing a transaction location acquisition process of acquiring location information for transaction target person at the time of approval indicating current location information of the transaction target person when the approval of the electronic commerce is executed;
   executing a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

An approval method of electronic commerce according to the second aspect of the present invention, for approving a given electronic commerce based on a crypto-asset when the electronic commerce is executed by a supplier and a client, the approval method has:
managing activity location and scope information which is information registered in advance in a storage unit, and which indicates a location or scope of an activity, serving as a reference for an activity of each user who is a supplier or a client;
identifying a transaction target person based on transaction target person information relating to at least one of the supplier and the client, the transaction target person information being transmitted from a server when the electronic commerce between the supplier and the client is executed by the server;
executing an approval process of approving the electronic commerce between the identified supplier and the client;
providing the result of the approval process to the server, wherein
the approval process includes:
   a transaction location acquisition process of acquiring location information for transaction target person at the time of approval indicating current location information of the transaction target person when the approval of the electronic commerce is executed; and
   a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

An electronic commerce management system according to the third aspect of the present invention, for managing an electronic commerce when the electronic commerce is executed by a supplier and a client based on a crypto-asset, the electronic commerce management system has:
a management unit for managing user-related information that indicates information relates the user and is registered in advance in a storage unit, the user-related information including activity location and scope information that indicates information of a location or scope of an activity, serving as a reference for an activity of user who is a transaction target of at least one of the supplier and the client;
a transaction process unit for executing, as transaction process, process relating to the electronic commerce by the supplier and the client;
an approval process unit for executing an approval process of approving the electronic commerce;
a registration unit for registering the electronic commerce information of the approved electronic commerce in a plurality of databases in a distributed manner; and
the approval process unit performs the approval process:
   executing a transaction location acquisition process of acquiring location information for transaction target person at the time of approval indicating current location information of the transaction target person when the approval of the electronic commerce is executed; and
   executing a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

(4) A method of electronic commerce according to the fourth aspect of the present invention, for approving a given electronic commerce based on a crypto-asset when the electronic commerce is executed by a supplier and a client, the method has:
managing user-related information that indicates information relates the user and is registered in advance in a storage unit, the user-related information including activity location and scope information that indicates information of a location or scope of an activity, serving as a reference for an activity of user who is a transaction target of at least one of the supplier and the client;
executing, as transaction process, process relating to the electronic commerce by the supplier and the client;
executing an approval process of approving the electronic commerce; and
registering the electronic commerce information of the approved electronic commerce in a plurality of databases in a distributed manner, wherein
the approval process includes:
   a transaction location acquisition process of acquiring location information for transaction target person at the time of approval indicating current location information of the transaction target person when the approval of the electronic commerce is executed; and
   a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

### BRIEF DESCRIPTION OF DRAWINGS

FIG. 1 is a system configuration diagram illustrating an embodiment of an information system configuration.

FIG. 2 is one example of a diagram illustrating functional blocks of the electronic commerce management server of the present embodiment.

FIG. 3 is one example of a diagram illustrating functional blocks of the approval server of the present embodiment.

FIG. 4 is a diagram for explaining the approval process executed by the approval server of the present embodiment with the various processes of the electronic commerce performed by the electronic commerce management server.

FIG. 5 is a diagram illustrating an example of task information stored in a memory unit in the embodiment of the present invention.

FIG. 6 is a diagram illustrating an example of task information stored in a storage unit in the embodiment of the present invention.

FIG. 7 is a flowchart illustrating the operation of the approval process executed by the approval server of the present embodiment.

FIG. 8 is a system configuration diagram illustrating an embodiment of an information system.

(1) In the embodiment of the present invention, the approval method of electronic commerce for approving a given electronic commerce based on a crypto-asset when the electronic commerce is executed by a supplier and a client, the approval method has:
a management unit for managing activity location and scope information which is information registered in advance in a storage unit, and which indicates a location or scope of an activity, serving as a reference for an activity of each user who is a supplier or a client;
an identifying unit for identifying a transaction target person based on transaction target person information relating to at least one of the supplier and the client, the transaction target person information being transmitted from a server when the electronic commerce between the supplier and the client is executed by the server;
an approval process unit for executing an approval process of approving the electronic commerce between the identified supplier and the client;
a providing unit that provides the result of the approval process to the server, wherein
   executing a transaction location acquisition process of acquiring location information for transaction target person at the time of approval indicating current location information of the transaction target person when the approval of the electronic commerce is executed; and
   executing a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

As another embodiment of the present invention, the present invention can be realized by the approval method of the electronic commerce for executing each of the above processes, the electronic commerce management system for performing electronic commerce using the above electronic commerce approval system, or the method of the electronic commerce for performing each of the above processes.

Based on this configuration, the one embodiment of the present invention can determine the authenticity of the supplier and the client based on the residence or the scope of the activity of the supplier and the client, and therefore, can perform the approval or refusal of approval in electronic commerce.

Specifically, the embodiment of the present invention can reliably specify the cash flow when the electronic commerce using the crypto-asset or the transaction of the crypto-asset itself is executed or the history (tracking) of the product and the service which are the objects of the electronic commerce based on the authenticity of the supplier and the client as the transaction person.

In other words, by approving the electronic commerce based on the location or the scoop of the activity of the supplier and the client, the one embodiment of the present invention can prevent risks that includes:
(A1) disadvantages due to the absence of a central administrator for crypto assets (lack of stability due to value guarantees for the legal tender) and the like;
(A2) reduction of the credibility risk of the commercial transactions based on non-face-to-face transactions (reduction of the reliability of information such as whether the supplier and the client exist); and
(A3) the occurrence of the illegal transactions based on such reduced credit risk (exploitation of assets and funds or their use for money laundering).

Therefore, the embodiment of the present invention can achieve the fair trade, authentic transactions and highly reliable transactions in the electronic commerce using the crypto-assets.

The “Crypto-assets” indicate property values that can be exchanged over networks such as the Internet, and are assets that can be used for payment of goods in commercial transactions, can be exchanged with legal tender, and can be electronically recorded and transferred.

For example, Bitcoin, Ethereum and the like are known as typical crypto-assets. Additionally, the “crypto-assets” in this embodiment may include the legal tender (the electronic legal tender) issued in digital form such as “yen”, “dollar”, “euro”, or “yuan”.

The electronic commerce indicates conducting commercial transactions such as the sale of products or services, exchanging crypto-assets as consideration for products or services, or exchanging crypto-assets for legal tender as consideration for the acquisition of crypto-assets (i.e., a commercial transaction to sell or buy crypto-assets themselves) by electronic means on a network or computer.

The “supplier” is a user who conducts a transaction to provide the transaction object or offer the transaction, such as a product or service in the electronic commerce, and the “client” is a user who conducts a transaction to obtain a proposed transaction object in exchange for payment of a price in the electronic commerce.

The “location of an activity” indicates a geographical location obtained mainly by the satellite positioning system in the real space where the user's activity is performed, and the “scope of the activity” indicates a geographical scope in the real space where the user's activity is performed.

The “electronic commerce information” includes information such as types of funds or types of products or services, distribution channels including information on past suppliers and clients, past transaction dates or date-times, past transaction volumes, and past transaction amounts.

The “trading target person condition” includes at least a condition that the trading target person location at the time of approval of the supplier or the client coincides with or is regarded as coinciding with the activity location registered as the trading target person, or belongs to the scope of the activity registered as the trading target person.

(2) In the embodiment of the present invention,
the management unit: acquires current location information indicating a current location of the user at a given timing or at each predetermined timing; and registers the acquired current location information in the storage unit as historical information of an activity location and scope of the user, and
the approval process unit executes, as the approval process, the condition determination process based on: at least one of the acquired location information of the transaction target user at the time of approval and historical information of the transaction target user already registered; and the registered activity location and scope information of the transaction target user.

Based on this configuration, the embodiment of the present invention can continuously recognize the location of the activity and the scope of the activity of the supplier or the client at the time of approval of the electronic commerce. Therefore, it is difficult to disguise the location of the activity or the scope of the activity of the supplier or the client, and more the one embodiment of the present invention can realize the more fair trade, the authentic transactions and the highly reliable transactions in the electronic commerce using the crypto-assets.

The “given timing” includes, for example, the time when the user registers for a service for performing the electronic commerce as the user, the time when the user uses the service for the first time as the user, or the timing when the service provider is requested.

The “every predetermined timing” includes once a day or a week, or every time a user logs in to a service for performing electronic commerce.

The “transaction target person determination process” includes, in addition to or in place of the above-described transaction target person conditions, determining whether or not the location or the scoop of the activity of the user of the transaction target person acquired at a given timing or at each predetermined timing

(3) In the embodiment of the present invention,
the management unit: acquires the current location information indicating a current location of the user at a given timing or at each predetermined timing; and executes a determination process of the scope of activity for determining authenticity of the scope of activity of the user by comparing the acquired current location information and activity location and scope Information registered the activity location and scope information of the corresponding user, and
the approval process unit rejects, as the approval process, the approval of a target electronic commerce when the user whose authenticity of the scope of the activity is denied by the determination process of the scope of activity is at least one of the supplier and the client.

Based on this configuration, the embodiment of the present invention can always continuously recognize the location of the activity and the scope of the activity of the supplier or the client. Therefore, it is difficult to disguise the location of the activity or the scope of the activity of the supplier or the client, and more the one embodiment of the present invention can realize the more fair trade, the authentic transactions and the highly reliable transactions in the electronic commerce using the crypto-assets.

(4) In the embodiment of the present invention,

the current location information includes timing information indicating a timing when the current location information is acquired.

Based on this configuration, the embodiment of the present invention can recognize the location of the activity or the scope of the activity in time series, and therefore, can continuously recognize the location of the activity and the scope of the activity including the location or scope of the activity without contradiction and whether it is a change in time.

Therefore, it is difficult to disguise the location of the activity and the scope of the activity of the supplier or the client, and to disguise the date-time, and therefore the one embodiment of the present invention can realize the more fair trade, the authentic transactions and the highly reliable transactions in the electronic commerce using the crypto-assets.

The “timing information” includes, for example, information indicating a date synchronized with location information such as GPS, information indicating a date and time, or information indicating a time.

(5) In the embodiment of the present invention,
the server registers the information relating to the electronic commerce as electronic commerce information in a plurality of databases in a distributed manner, and
the electronic commerce information is formed by block information which is blocked based on a plurality of pieces of commercial transaction information including the commercial transaction information and a hash value determined from past commercial transaction information when the electronic commerce is approved.

Hereinafter, preferred embodiments of the present invention will be described.

The embodiment described below is an embodiment in which the electronic commerce approval system, the electronic commerce management system, and the like of the present application are applied to an electronic commerce system using a network that has a commerce transaction management server for managing electronic commerce, a terminal device used by a user who performs electronic commerce, and an approval server for approving the electronic commerce, and registers information on electronic commerce in a plurality of databases in a distributed manner.

### [1] Electronic Commerce System

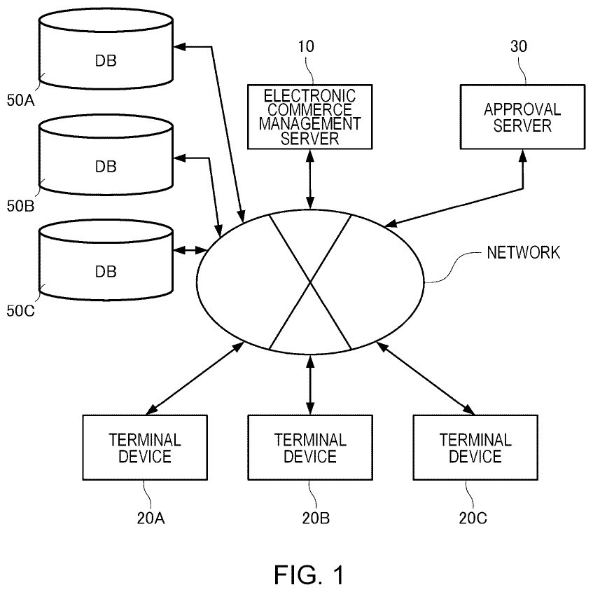

First, the outline and system configuration of an electronic commerce system S in the present embodiment will be described with reference FIG. 1.

FIG. 1 is a system configuration diagram illustrating an embodiment of an electronic commerce system configuration.

In order to prevent the drawings from becoming complicated, only some terminal devices 20 used by users and only some databases 50 are shown in FIG. 1. In other words, the electronic commerce system S has more terminal devices 20 and more databases 50 than shown on FIG. 1.

### (Outline of the System)

As shown in FIG. 1, the electronic commerce system S of the present embodiment is a system for realizing commercial transactions such as a sale of products or services by electronic means on a network or a computer using crypto-assets.

The electronic commerce system S has a configuration for realizing commercial transactions between a user (i.e., a supplier) who performs a transaction to propose the provision or transaction of a transaction object such as a product in the electronic commerce, and a user (i.e., a client) who performs a transaction to obtain the proposed transaction object in exchange for payment of a price in the electronic commerce.

Specifically, the embodiment of the present invention has a feasible configuration for the fair trade, authentic transactions and highly reliable transactions in the electronic commerce using the crypto-assets, in order to reliably identify the cash flow when the electronic commerce using crypto-assets is executed or the history (tracking) of a product that has been the subject of the electronic commerce, based on the authenticity of the supplier and the customer.

### (System Configuration)

As shown in FIG. 1, the electronic commerce system S of the present embodiment has: an electronic commerce management server 10 to execute various processes for managing electronic commerce; terminal device 20 (for example, terminal devices 20A, 20B, and 20C) connected to the electronic commerce management server 10 through a network such as the Internet and used by a user who performs electronic commerce; and an approval server 30 to execute various processes for approving electronic commerce in conjunction with the electronic commerce management server 10.

The electronic commerce management server 10 is an information processing device that executes various processes related to the electronic commerce using, for example, an API (application programming interface) or a predetermined platform.

The electronic commerce management server 10 may be configured by one device (or processor) or a plurality of devices (or processors).

Specifically, the electronic commerce management server 10 is configured; to manage the electronic commerce between the supplier and the customer, and when the electronic commerce is approved by the approval server 30, and; to register the electronic commerce information in a database (hereinafter, also referred to as “DB”) 50.

The electronic commerce management server 10 is configured to register the electronic commerce information in a plurality of databases 50 using a distributed ledger technology such as a blockchain which is difficult to be falsified.

In particular, the electronic commerce management server 10 configured: to generate block information by blocking the electronic commerce information based on a plurality of electronic commerce information and a hash value determined from past electronic commerce information; and to register the block information in each database 50.

The terminal device 20 is a communication terminal device that serves as an information processing device used by users such as a PC (personal computer), a tablet-type information communication terminal device, a smart phone, a mobile phone and an HMD.

The terminal device 20 is connectable to the electronic commerce management server 10 via a network such as the Internet (WAN) or a LAN, and has a configuration for establishing a communication line with the electronic commerce management server 10 by wire or wireless to transmit and receive various data.

The terminal device 20 has a communication control function for communicating input information input by the user with the electronic commerce management server 10, a function for acquiring the current location of the user, and a display function for performing display control using data received from the electronic commerce management server 10.

The approval server 30 is an information processing device that executes various processes related to the electronic commerce using, for example, an API (application programming interface) or a predetermined platform, as in the case of the electronic commerce management server 10.

The approval server 30 may be configured by a single device or processor, or a plurality of devices or processors, as in the case of the electronic commerce management server 10.

The approval server 30 is configured to execute an approval process for approving the electronic commerce by determining the authenticity of the supplier and the customer based on the location information of the supplier and the customer.

The database 50 may be configured by various databases (storage devices and memories in a broad sense) such as a hard disk drive connectable to the network N, or may be added in an information processing device connected to the network N such as a PC (personal computer) or a server.

### [2] Electronic Commerce Management Server

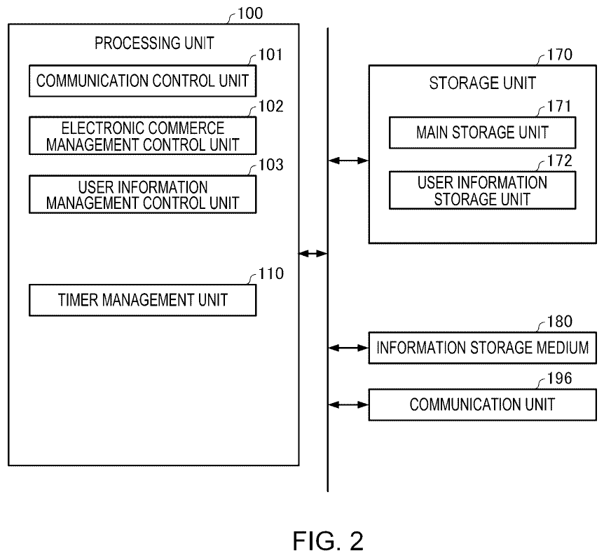

Next, the electronic commerce management server 10 of the present embodiment will be described with reference to FIG. 2.

FIG. 2 is one example of a diagram illustrating functional blocks of the electronic commerce management server 10 of the present embodiment.

As illustrated in FIG. 2, the electronic commerce management server 10 of the present embodiment includes a processing unit 100, a storage unit 170, an information storage medium 180, and a communication unit 196.

The electronic commerce management server 10 of the present embodiment may be configured by omitting one or more composing elements shown in FIG. 2.

The storage unit 170 serves as a work area for the processing unit 100, and the like, and its functions are configured by a RAM (VRAM) or the like.

Specifically, the storage unit 170 includes a main storage unit 171 used for a work area used when various processes are executed, and a user information storage unit 172 storing user information.

The storage unit 170 of the present embodiment may be configured such that a part of the configuration of the main storage unit 171 and the user information storage unit 172 is omitted.

The information storage medium 180 is readable by a computer, and programs, data, and the like are stored in the information storage medium 180. In other words, the information storage medium 180 stores programs for causing the computer to function as the respective units of the present embodiment (programs for causing the computer to execute the processing of the respective units).

The processing unit 100 can perform the various processes of the present embodiment based on data read out from programs (data) stored in the information storage medium 180.

For example, the information storage medium 180 is an optical disk (CD, DVD), a magneto-optical disk (MO), a magnetic disk, a hard disk, a flash memory such as a solid state drive, a magnetic tape, a memory (ROM), or a memory card.

The communication unit 196 performs various controls to communicate with an external device (for example, the terminal device 20 or the approval server 30). The functions of the communication unit 196 is configured by hardware of various processors or ASICs for communication, program and so on.

The processing unit 100 performs the various processes of the present embodiment based on programs (data) stored in the information storage medium 180.

The processing unit 100 of the present embodiment may read out the program and data stored in the information storage medium 180, temporarily store the read out program and data in the storage unit 170, and perform processing based on the program and data.

The processing unit 100 executes various processes using the main storage unit 171 in the storage unit 170 as a work area. The processing unit 100 is implemented by hardware such as various processors (CPU, DSP, etc.), and programs.

Specifically, the processing unit 100 includes a communication control unit 101, an electronic commerce management control unit 102, a user information management control unit 103, and a timer management unit 110.

The communication control unit 101 establishes communication lines with the terminal device 20 and the approval server 30 through the network and performs communication with each other.

The electronic commerce management control unit 102 works the terminal devices 20 of the users of the customer and the supplier, and executes a process for managing the transaction.

The electronic commerce management control unit 102 manages the transaction object, such as products sold by the supplier, and executes the processes related to transactions with the customer who desires to purchase the products, and various processes for executing the payment of the consideration when the transactions are successful.

Specifically, the electronic commerce management control unit 102: works with the approval server 30. When the electronic commerce such as a transaction of the sale of a product is executed, for example, the electronic commerce management control unit 102 receives the result of the approval processing of the electronic commerce in the approval server 30. The electronic commerce management control unit 102 executes each process after the transaction is successful or each process after the transaction is unsuccessful based on the received result.

The user information management control unit 103 manages information of each user as a supplier or a customer.

Specifically, the user information management control unit 103 manages, for example, registration and update of information required for selling a transaction object such as a product and information required for purchasing the transaction object in the user information storage unit 172.

The timer management unit 110 has a function of performing measurement from the current date and time or a predetermined timing, and outputs the current time or a measurement result when the predetermined timing is detected.

### [3] Approval Server

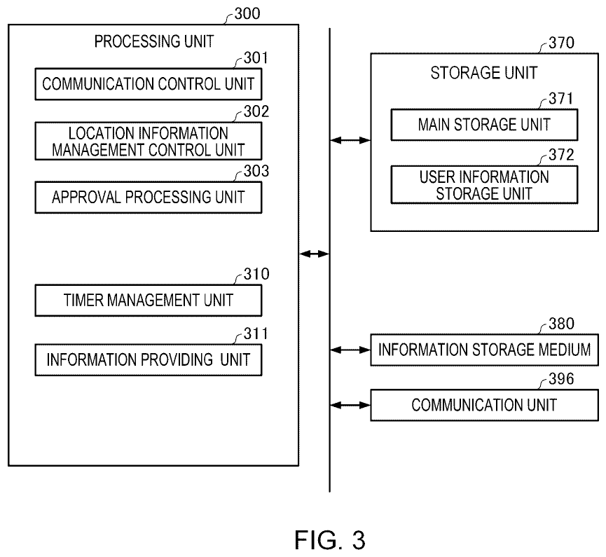

Next, the configuration according to the approval server 30 of the present embodiment will be described with reference to FIG. 3.

FIG. 3 is one example of a diagram illustrating functional blocks of the approval server 30 of the present embodiment.

As illustrated in FIG. 3, the approval server 30 of the present embodiment includes a processing unit 300, a storage unit 370, an information storage medium 380, and a communication unit 396.

The approval server 30 of the present embodiment may be configured by omitting one or more composing elements shown in FIG. 3.

The storage unit 370 serves as a work area for the processing unit 300, and the like, and its functions are configured by a RAM (VRAM) or the like.

Specifically, the storage unit 370 includes a main storage unit 371 used for a work area used when various processes are executed, and a user information storage unit 372 storing user location/scope information in which location information is defined, is defined the scope of the activity of each user are stored, or both.

In particular, the user information storage unit 372 stores, for each user, in association with user identification information (UID), information (hereinafter referred to as “reference information on the location of the activity”) of which a location (hereinafter referred to as “location of activity for reference”) serves as the reference for each user's activity and which has a latitude and a longitude; information (hereinafter referred to as “reference information on the activity scope”) of which a specified scope or area (hereinafter referred to as “scope of activity for reference”) is centered on the location of activity for reference; or both, as reference information on activity location and scope.

The storage unit 370 of the present embodiment may be configured such that a part of the configuration having the main storage unit 371 and the user information storage unit 372 is omitted.

The information storage medium 380 is readable by a computer, and programs, data, and the like are stored in the information storage medium 380. In other words, the information storage medium 380 stores programs for causing the computer to function as the respective units of the present embodiment (programs for causing the computer to execute the processing of the respective units).

The processing unit 300 can perform the various processes of the present embodiment based on data read out from programs (data) stored in the information storage medium 380.

For example, the information storage medium 380 is an optical disk (CD, DVD), a magneto-optical disk (MO), a magnetic disk, a hard disk, a flash memory such as a solid state drive, a magnetic tape, a memory (ROM), or a memory card.

The communication unit 396 performs various controls to communicate with the electronic commerce management server 10. The functions of the communication unit 396 is configured by hardware of various processors or ASICs for communication, program and so on.

The processing unit 300 performs the various processes of the present embodiment based on programs (data) stored in the information storage medium 380. The processing unit 300 of the present embodiment may read out the program and data stored in the information storage medium 380, temporarily store the read out program and data in the storage unit 370, and perform processing based on the program and data.

The processing unit 300 executes various processes using the main storage unit 371 in the storage unit 370 as a work area. The processing unit 300 is implemented with hardware such as various processors (CPU, DSP, etc.), and programs.

Specifically, the processing unit 300 includes a communication control unit 301, a location information management control unit 302, an approval processing unit 303, a timer management unit 310, and an information providing unit 311.

The communication control unit 301 establishes communication lines with the electronic commerce management server 10 through the network and performs communication with each other.

The location information management control unit 302 manages location information, information on activity scope, and historical information of the supplier or the client.

Specifically, the location information management control unit 302 manages registration and update of information required for selling a transaction object and for purchasing the transaction object, as a location information of the supplier or the client, in the user information storage unit 172, such as the information (i.e., the reference information on activity location) of which a location serves as the reference for each user's activity, or the information of scope of activity (i.e., the reference information on activity scope”).

When the electronic commerce transaction is executed, the approval processing unit 303 executes an approval process for determining whether or not to approve the electronic commerce transaction based on the location information of the supplier, the client, or both, in conjunction with the electronic commerce management server 10.

The timer management unit 310 has a function of performing measurement from the current date and time or a predetermined timing, and outputs the current time or a measurement result when the predetermined timing is detected.

The information providing unit 311 provides the electronic commerce management server 10 with approval determination result information indicating a determination result by the approval processing.

### [4] Method of the Present Embodiment

### [4.1] Outline

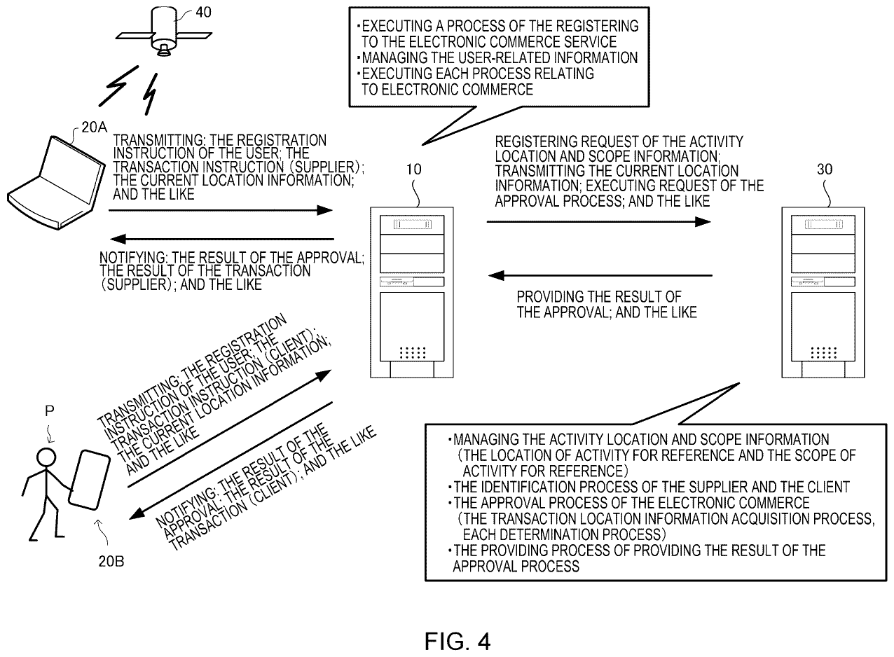

Next, an approval process executed by the approval server 30 of the present embodiment will be described with reference to FIG. 4.

FIG. 4 is a diagram for explaining the approval process executed by the approval server 30 of the present embodiment with the various processes of the electronic commerce performed by the electronic commerce management server 10.

As shown in FIG. 4, the approval server 30 of the present embodiment is configured to execute the approval process for approving whether or not an electronic commerce executed by the electronic commerce management server 10 is a legitimate transaction based on an location of an activity or scope of an activity of at least one of a supplier and a client transaction destination of the electronic commerce and time.

In other words, the approval server 30 of the present embodiment is a device for approving a given electronic commerce based on a crypto-asset such as Bitcoin or Ethereum when the supplier and the client execute the electronic commerce based on the location information of the supplier and the client.

Specifically, as shown in FIG. 4, the electronic commerce management server 10 of the present embodiment is configured to manage user related information relating to users registered in the electronic transaction service and to execute a process of registration in the electronic commerce service and a process relating to the electronic commerce based on instructions of suppliers and clients transmitted from the terminal device 20.

As shown in FIG. 4, the approval server 30 of the present embodiment is configured to receive information on the current position of the user transmitted from the terminal device 20 via the electronic commerce management server 10 when the electronic commerce management server 10 executes a process relating to electronic commerce, determine the authenticity of at least one of the supplier and the client based on the received information, and execute approval processing for approving the electronic commerce.

The approval server 30 of the present embodiment is configured to approve electronic commerce based on the location or the scope of activity and time of the supplier and the customer, in order to prevent risks that includes:
(A1) disadvantages due to the absence of a central administrator for crypto assets (lack of stability due to value guarantees for the legal tender) and the like;
(A2) reduction of the credibility risk of the commercial transactions based on non-face-to-face transactions (reduction of the reliability of information such as whether the vendor and the client exist); and
(A3) the occurrence of the illegal transactions based on such reduced credit risk (exploitation of assets and funds or their use for money laundering).

More specifically, as shown in FIG. 4, the approval server 30 is configured to manage activity location and scope information indicating information (hereinafter, referred to as “location of activity for reference”) of the location of an activity (hereinafter, also referred to as “location of activity for reference”) serving as a reference for the activity of each user, or the scope of an activity (hereinafter, also referred to as “scope of activity for reference”) serving as a reference for the activity of each user.

As shown in FIG. 4, the approval server 30 is configured to execute the processes including:
(B1) a specifying process for specifying a transaction target person based on transaction target information relating to at least one of the supplier and the transaction target person transmitted from the electronic commerce management server 10 when the electronic commerce management server 10 performs the electronic commerce by the supplier and the client;
(B2) an approval process for approving the electronic commerce of the specified transaction target person; and
(B3) a process for providing the result of the approval processing to the electronic commerce management server 10.

As shown in FIG. 4, the approval server 30 is configured to
(B2-1) executing a transaction location acquisition process for acquiring location information of the transaction target person at the time of approval who indicates current location information of a transaction target person when executing approval of electronic commerce; and
(B2-2) executing a condition determination process for comparing the location information of the transaction target person at the time of approval and the activity location and scope information that is stored and that is used for the user who is transaction target person,
in order to determine whether or not the electronic commerce is approved based on the result of the determination of the executed condition determination process.

The electronic commerce management server 10 is configured to register, when the electronic commerce is approved, information of the approved electronic commerce as electronic commerce information in a distributed manner in a plurality of databases 50.

The electronic commerce management server 10 stores as the electronic commerce information such as types of funds or types of products or services, distribution channels including information on past suppliers and clients, past transaction dates or date and times, past transaction volumes, and past transaction amounts.

FIG. 4 shows an example of the terminal devices 20A and 20B that acquire location information based on the GPS signal transmitted from the GPS satellite 40, transmit the acquired position information to the approval server 30 via the electronic commerce management server 10, transmit a registration instruction to the electronic commerce service, transmit a transaction instruction for the supplier, receive the result of the approval process, and receive the transaction result of the transaction.

In particular, FIG. 4 shows an example in which a laptop is used as the terminal device 20A and a smartphone owned by the user P is used as the terminal device 20B.

FIG. 4 shows an example of the electronic commerce management server 10 that executes a process of the registering to the electronic commerce service, a process of managing user-related information used for executing each process relating to electronic commerce, and each process relating to electronic commerce.

FIG. 4 discloses an example of an approval server 30 that executes: the registration request of the activity location and scope information from electronic commerce management server 10; management information of the current position of the terminal device 20, or the activity location and scope information (the location of the activity and the scope of activity for reference) based on request of the approval process; identification process of the supplier and the client; the approval process of the electronic commerce (the transaction location information acquisition process and each determination process); or the providing process of providing the result of the approval process.

Based on this configuration, the approval server 30 of the present embodiment can reliably specify the cash flow when the electronic commerce using the crypto-asset or the transaction of the crypto-asset itself is executed or the history (tracking) of the product and the service which are the objects of the electronic commerce based on the authenticity of the supplier and the client as the transaction person.

Therefore, the approval server 30 of the present embodiment can achieve the fair trade, authentic transactions and highly reliable transactions in the electronic commerce using the crypto-assets.

### [4.2] Activity Location and Scope Information

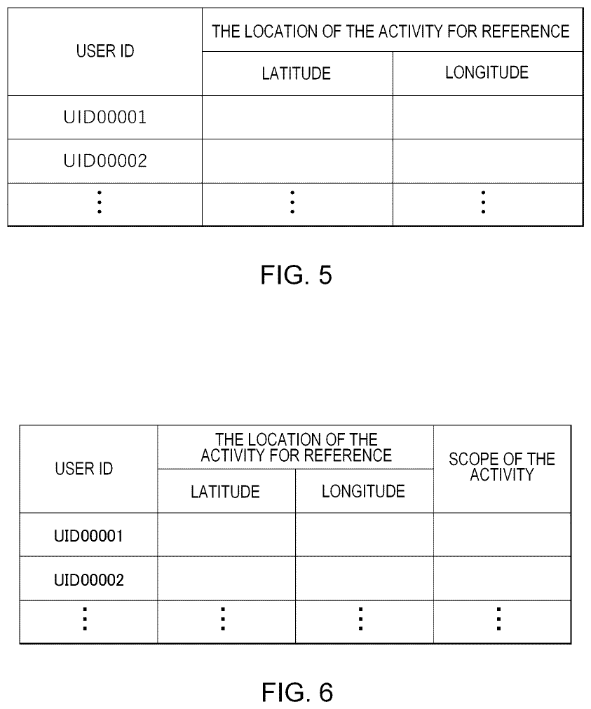

Next, the activity location and scope information, supplier's location information at the time of approval, and client's location information at the time of approval of the present embodiment will be described with reference to FIG. 5.

FIG. 5 is a diagram illustrating an example of the activity location and scope information (reference information on activity location) stored in the user information storage unit 372 according to the present embodiment. FIG. 6 is a diagram illustrating an example of the activity location and scope information (reference information on activity scope) stored in the user information storage unit 372 according to the present embodiment.

### (Activity Location and Scope Information)

The activity location and scope information includes information on an activity reference location serving as a reference for an activity of each user (i.e., activity reference position information) and information on an scope of activity serving as a reference for the user (i.e., activity reference range information).

The location of activity for reference indicates a geographical location in the real space where the user's activity is performed. For example, a location input by the user when performing membership registration in an electronic commerce service for trading products or services or the user's current location acquired at the time of membership registration is used.

For example, the location of activity for reference has a latitude predetermined on the earth with the equator being 0 degree, and a longitude determined by a meridian formed by a great circle connecting the north pole and the south pole so as to intersect the equator at a right angle.

The reference information on activity location is stored in the user information storage unit 372 for each user identification information under the operation input of the terminal device 20 of each user through the transaction management server 10 when the user is newly registered in the electronic commerce service.

For example, the reference information on activity location includes, as shown in FIG. 5,
(A1) a user ID (UID) as user identification information; and
(A2) the longitude and the latitude as the location of activity for reference.

For example, the reference information on activity location of the user is acquired by using a GPS positioning system using a GPS satellite as information of the present location at the time of registration to the electronic commerce service.

The scope of activity for reference indicates a geographical scope in the real space where the activity of the user is performed, and a geographical scope input by the user, or a scope predetermined based on the current location acquired at the time of membership registration is used as in the location of activity for reference.

For example, the scope that is predetermined based on the current location may be a regional scope to which the current location belongs, such as a municipality, a prefecture, or a country, or a scope within a predetermined scope from the current location.

As with the activity reference location, the reference information on activity scope is stored in the user information storage unit 372 for each user identification information under the operation input of the terminal device 20 of each user through the electronic commerce management server 10 when the user is newly registered in the electronic commerce service.

For example, the reference information on activity location includes, as shown in FIG. 6:
(A1) a user ID (UID) as user identification information;
(A2) the longitude and the latitude as the location of activity for reference; and
(A3) scope of activity.

### (Supplier's Location Information at the Time of Approval and Client's Location Information at the Time of Approval)

The supplier's location information at the time of approval indicates the current location of the terminal device 20 of the supplier at the time of execution of the electronic commerce, and is configured by latitude and longitude.

The client's location information at the time of approval indicates the current location of the terminal device 20 of the client at the time of execution of the electronic commerce, and is configured by latitude and longitude.

### [4.3] Managing Location Information

Next, the process executed by the approval server 30 of the present embodiment, which is the management of the location information of the supplier and the client, will be described.

The location information management control unit 302 manages the reference information on activity location or the reference information on activity scope, and manages a location of an activity or scope of an activity and time historical information as the supplier or the client.

The location information management control unit 302 works with the electronic commerce management server 10, and acquires, when a user is registered in the electronic commerce service, the activity location and scope information that indicates: the information on the location of activity for reference (the reference information on activity location) serving as a reference for the activity of each user; or the information on the scope of activity for reference (the reference information on activity scope) serving as a reference for the activity of each user, and registers the activity location and scope information in the user information storage unit 372.

The location information management control unit 302 may acquire location information indicating the current location of the user acquired at a given timing or at each predetermined timing, and register the acquired location information in the user information storage unit 372 as historical information indicating the history of the location of each user.

The location information management control unit 302 may continuously recognize the location of the activity and scope of the activity of the activity of the user who may be a supplier or a client of electronic commerce. The location information management control unit 302 may register the location information indicating the current location of the user, which is acquired at a given timing or at each predetermined timing, as historical information in the user location related information storage unit (372) in order to use the information for approval process.

For example, the location information management control unit 302 uses a timing (for example, once or a timing of using the service) requested by the electronic commerce service provider when the user uses the electronic commerce service for the first time, in addition to the time of registering the user in the electronic commerce service as a new user.

The location information management control unit 302 uses, as the predetermined timing, such as once a day or a week, or a timing of logging in to the service for electronic commerce.

### [4.4] Identification Process

Next, the process executed by the approval server 30 of the present embodiment, which is the identification process to execute the electronic commerce, will be described.

The location information management control unit 302 works with the electronic commerce management server 10 and executes an identification process for specifying the user (i.e., a transaction target) of the supplier and the client when executing the approval process.

Specifically, the location information management control unit 302 receives the user identification information (e.g., UID) of the supplier and the user identification information of the client, transmitted from the electronic commerce management server 10 via the communication control unit 301.

The location information management control unit 302 searches the user information storage unit 372 based on the user identification information (hereinafter referred to as “received user identification information”) of the supplier and the client.

When the location information management control unit 302 detects the user identification information that matches the received user identification information and that is stored in the user information storage unit 372, the location information management control unit 302 identifies the user having the detected user identification information as the supplier or the client.

### [4.5] Approval Process

### (Basic Principles of Approval Process)

Each time an electronic commerce is executed, the approval processing unit 303 determines whether or not the supplier and the client, who are transaction users of the electronic commerce transmitted from the electronic commerce management server 10, are authentic. When the supplier and the client are authentic, the approval processing unit 303 executes the approval process for approving the electronic commerce.

The approval processing unit 303 determines: the authenticity of the supplier and the client based on the authenticity of the user (including an organization such as a company) who lives in the real world; and the user determined to be a user who exists as a person who is not a member of an anti-social force.

Specifically, the approval processing unit 303 executes:
(A1) a transaction location acquisition process for acquiring the current locations of the supplier and the client specified by the identifying process;
(A2) a supplier determination process for determining the authenticity of the supplier based on the acquired current location of the supplier; and
(A3) a client determination process for determining the authenticity of the client based on the acquired current location of the client, as in the case of the supplier.

When the supplier is determined to be authentic by the supplier determination process and the client is determined to be authentic by the client determination process, the approval processing unit 303 approves the electronic commerce, and when the supplier or the client is determined to be not authentic, the approval processing unit 303 rejects the electronic commerce without approving the electronic commerce.

For example, when one of the suppliers or the clients is a user whose authenticity has already been determined, such as a public institution, the approval processing unit 303 may execute the acquisition process and the authenticity determination only on one of the suppliers or the clients.

### (Transaction Location Acquisition Process)

The approval processing unit 303 acquires, from the electronic commerce management server 10, the current location information when the electronic commerce of the terminal device 20 of the supplier and the client as supplier's location information at the time of approval and client's location information at the time of approval.

For example, the approval processing unit 303 acquires the current location of the timing when the electronic commerce is executed by the client (i.e., the buyer) as the client's location information at the time of approval and the current location of the timing when the electronic commerce is executed by the supplier (i.e., the seller) as the supplier's location information at the time of approval.

The approval processing unit 303 may directly acquire the supplier's location information at the time of approval or the client location information at the time of approval from the corresponding terminal device 20.

### (Condition Determination Process 1: Supplier Determination Process)

As the supplier determination process, the approval processing unit 303 compares the acquired supplier's location information at the time of approval with the registered activity location and scope information of the user who becomes the supplier, and determines whether or not the result of the comparison satisfies a given supplier's condition.

For example, the approval processing unit 303 uses, as a supplier's condition: that the supplier's location at the time of approval of the supplier coincides with or is regarded as coinciding with the registered location of activity for reference of the supplier; or that the supplier's location is within the registered scope of activity for reference of the supplier.

Specifically, when the supplier's location at the time of approval completely matches the registered location of activity for reference of the supplier, the approval processing unit 303 determines that the supplier's condition is satisfied and determines that the supplier is authentic.

Alternatively, when the supplier's location at the time of approval is within a predetermined scope (for example, within 100 m) from the registered location of activity for reference of the supplier, the approval processing unit 303 may determine that the supplier's condition is satisfied by assuming that the supplier's location at the time of approval matches the registered location of activity for reference of the supplier, and determines that the supplier is authentic.

Further, in place of the above, the approval processing unit 303 may determine that the supplier's condition is satisfied and the supplier is authentic when the supplier's location at the time of approval belongs to a predetermined scope of activity for reference such as a predetermined scope (for example, 10 km) from the same area or a predetermined point (a representative point of the area such as a point where a local government office is located).

On the other hand, when the supplier's condition is not satisfied, the approval processing unit 303 determines that the supplier is not authentic.

The approval processing unit 303 may execute the supplier determination process based on the historical information of the user as the supplier acquired at a given timing or at each predetermined timing as described above, in addition to or in place of the supplier's location information acquired at the time of approval.

In this case, the approval processing unit 303 executes the supplier determination process on the basis of the location indicated by the acquired supplier's location information at the time of approval, each past location (activity location) of the user indicated by historical information as a supplier already registered in the user location related information storage unit 372, and the location of activity for reference or scope of activity for reference registered as the supplier.

Based on this configuration, the embodiment of the present invention can continuously recognize the location of the activity and the scope of activity of the supplier or the client at the time of approval of the electronic commerce. Therefore, it is difficult to disguise the activity position or the scope of activity of the supplier or the client, and the embodiment of the present invention can realize the fair trade, the authentic transactions and the highly reliable transactions in the electronic commerce using the crypto-assets.

Specifically, when the supplier's location at the time of approval completely matches the registered location of activity for reference of the supplier, the approval processing unit 303 determines that the supplier's condition is satisfied and determines that the supplier is authentic.

Alternatively, when the supplier location at the time of approval and each activity location in each historical information are within a predetermined scope (for example, within 100 m) from the registered location of activity for reference of the supplier, the approval processing unit 303 may determine that the supplier's condition is satisfied by assuming that the supplier's location at the time of approval and the past location of activity match the registered location of activity for reference of the supplier, and determines that the supplier is authentic.

Further, in place of the above, the approval processing unit 303 may determine that the supplier's condition is satisfied and the supplier is authentic when the supplier's location at the time of approval and each activity location in each historical information are belongs to a predetermined scope of activity for reference such as a predetermined scope (for example, 10 km) from the same area or a predetermined point (a representative point of the area such as a point where a local government office is located).

### (Condition Determination Process 2: Client Determination Process)

As the supplier determination process, the approval processing unit 303 compares the acquired client's location information at the time of approval with the registered activity location and scope information of the user who becomes the client, and determines whether or not the result of the comparison satisfies a given client's condition.

For example, the approval processing unit 303 uses, as a client's condition: that the client's location at the time of approval of the client coincides with or is regarded as coinciding with the registered location of activity for reference of the client; or that the client's location is within the registered scope of activity for reference of the client.

Specifically, as with the supplier identification process, when the client's location at the time of approval completely matches the registered location of activity for reference of the client, the approval processing unit 303 determines that the client's condition is satisfied and determines that the client is authentic.

Alternatively, when the client's location at the time of approval is within a predetermined scope (for example, within 100 m) from the registered location of activity for reference of the client, the approval processing unit 303 may determine that the client's condition is satisfied by assuming that the client's location at the time of approval matches the registered location of activity for reference of the client, and determines that the client's is authentic.

Further, in place of the above, the approval processing unit 303 may determine that the client's condition is satisfied and the client is authentic when the client's location at the time of approval belongs to a predetermined scope of activity for reference such as a predetermined scope (for example, 10 km) from the same area or a predetermined point (a representative point of the area such as a point client's where a local government office is located).

On the other hand, as with the supplier identification process, when the supplier's condition is not satisfied, the approval processing unit 303 determines that the supplier is not authentic.

The approval processing unit 303 may execute, as with the supplier identification process, the client determination process based on the historical information of the user as the client acquired at a given timing or at each predetermined timing as described above, in addition to or in place of the supplier's location information acquired at the time of approval.

Based on this configuration, as with the supplier identification process, the embodiment of the present invention can continuously recognize the location of the activity and the scope of activity of the client or the client at the time of approval of the electronic commerce. Therefore, it is difficult to disguise the location of the activity or the scope of the activity of the client or the supplier, and the time, and the embodiment of the present invention can realize the more fair trade, the authentic transactions and the highly reliable transactions in the electronic commerce using the crypto-assets.

In this case, the approval processing unit 303 executes the client determination process on the basis of the location indicated by the acquired client's location information at the time of approval, each past location (activity location) of the user indicated by historical information as a client already registered in the user information storage unit 372, and the location of activity for reference or scope of activity for reference registered as the client.

Specifically, when the client's location at the time of approval completely matches the registered location of activity for reference of the client, the approval processing unit 303 determines that the client condition is satisfied and determines that the client is authentic.

Alternatively, when the client's location at the time of approval and each activity location in each historical information are within a predetermined scope (for example, within 100 m) from the registered location of activity for reference of the client, the approval processing unit 303 may determine that the client's condition is satisfied by assuming that the client's location at the time of approval and the past location of activity match the registered location of activity for reference of the supplier, and determines that the supplier is authentic.

Further, in place of the above, the approval processing unit 303 may determine that the client's condition is satisfied and the client is authentic when the supplier location at the time of approval and each activity location in each historical information are belongs to a predetermined scope of activity for reference such as a predetermined scope (for example, 10 km) from the same area or a predetermined point (a representative point of the area such as a point where a local government office is located).

### [4.6] Providing Process

Next, the providing process of providing the result of the approval process executed by the approval server 30 of the present embodiment to the electronic commerce management server 10 will be described.

When the approval is rejected by the approval process, the information providing unit 311 provides the electronic commerce management server 10 with result information indicating the result of the approval rejection by the approval process.

When the approval process succeeds in the approval, the information providing unit 311 provides the electronic commerce management server 10 with result information indicating the result of the successful approval.

The information providing unit 311 may provide the result information of the approval process to the terminal device 20 of the corresponding user (i.e., the user of the supplier and the client) via the electronic commerce management server 10 or directly.

When the result information indicates that the approval has failed, the electronic commerce management server 10 notifies the corresponding terminal device 20 of the result and terminates the corresponding electronic commerce as unsuccessful.

In the case of the result information indicating that the approval has succeeded, the electronic commerce management server 10 establishes the electronic commerce, converts the electronic commerce information into a predetermined format, and registers the electronic commerce information in a plurality of databases 50 in a distributed manner, while notifying the terminal device 20 of the fact.

### [5] Operation of the Present Embodiment

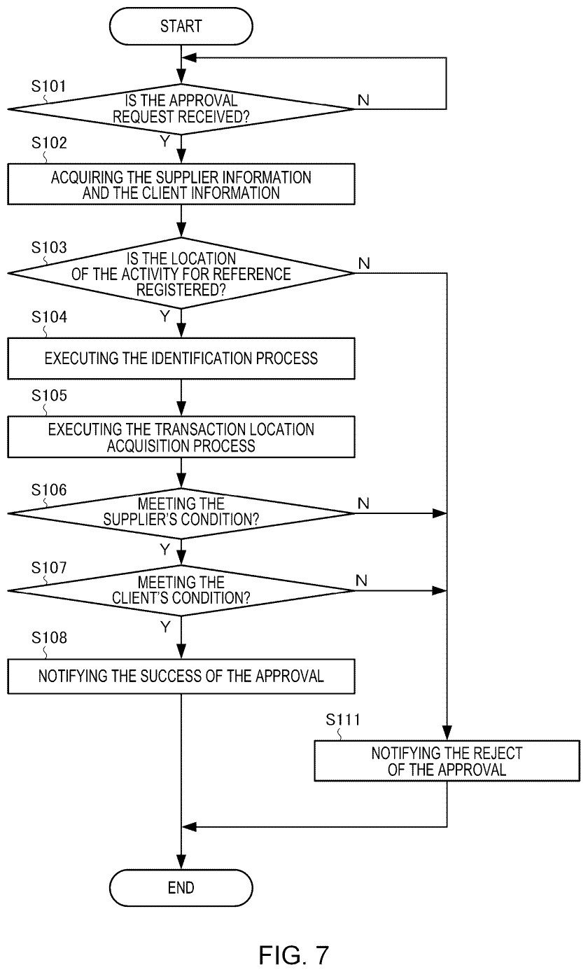

Next, the operation relating to the approval process executed by the approval server 30 of the present embodiment will be described with reference to FIG. 7.

FIG. 7 is a flowchart illustrating the operation of the approval process executed by the approval server 30 of the present embodiment.

In this operation, it is assumed that reference information on activity location serving as a reference of activity for a plurality of users is registered in advance as user location and scope information.

In this operation, it is assumed that the electronic commerce management server 10 executes each process related to electronic commerce with the corresponding terminal device 20, and that identification information and current location information of suppliers and clients have already been acquired from each terminal device 20.

First, when the approval processing unit 303 receives an approval request for electronic commerce from the electronic commerce management server 10 (step S101), the location information management control unit 302 acquires user identification information for identifying a supplier and a client from the electronic commerce management server 10 as supplier's information and client's information (step S102).

Next, the location information management control unit 302 searches the user information storage unit 372 based on the acquired user identification information of the supplier and the client, and determines whether or not the reference information on activity location based on the user identification information is stored in the user information storage unit 372 (step S103).

At this time, when the location information management control unit 302 determines that both of the acquired user identification information of the supplier and the client are stored as the user identification information of the reference information on activity location in the user information storage unit 372, the location information management control unit 302 proceeds to the process of step S104.

When it is determined that both of the acquired user identification information of the supplier and the client are not stored as the user identification information of the reference information on activity location in the user information storage unit 372, the information providing unit 311 transmits a notification indicating that the approval of the electronic commerce is rejected to the electronic commerce management server 10 (step S111), and terminates the operation.

Next, the location information management control unit 302 executes an identification process for identifying the supplier and the client having the user identification information stored in the user information storage unit 372 as the supplier and the client who execute the electronic commerce (step S104).

Next, the approval processing unit 303 executes transaction location acquisition process for acquiring the supplier's location information at the time of approval and the client's location information at the time of approval indicating the current locations acquired when executing the electronic commerce of the supplier and the client in the electronic commerce management server 10 (step S105).

Next, the approval processing unit 303 compares the supplier's location information at the time of approval with the activity location and scope information of the supplier, and executes the supplier determination process for determining whether or not the comparison result satisfies a given supplier's condition (step S106).

At this time, when the approval processing unit 303 determines that the comparison result satisfies the given supplier's condition, the process proceeds to step S107, and determines that the comparison result does not satisfy the given supplier's condition, the process proceeds to step S111 and the operation is terminated.

Next, the approval processing unit 303 compares the client's location information at the time of approval with the activity location and scope information of the client, and executes the client determination process for determining whether or not the comparison result satisfies a given client's condition (step S107).

At this time, when the approval processing unit 303 determines that the comparison result satisfies the given supplier condition, the process proceeds to step S108, and determines that the comparison result does not satisfy the given client's condition, the process proceeds to step S111 and the operation is terminated.

Next, the information providing unit 311 transmits a notification indicating that the approval of the corresponding electronic commerce has been successful to the electronic commerce management server 10 (step 108), and terminates this operation.

### [6] Modifications

### [6.1] Modification 1

Next, the case of the electronic commerce management server 10 that has the respective functions of the approval server 30 in the above embodiment will be described as a first modification of the present embodiment.

The electronic commerce management server 10 of the present modification has a configuration for executing an approval process: for determining the authenticity of a supplier or a client; and for approving the electronic commerce, when executing a transaction process of executing the electronic commerce by the supplier and the client using user-related information relating to a managed user.

Specifically, the electronic commerce management server 10 is configured to manage the activity location and scope information which is information registered in advance, and which indicates the location of activity for reference of the supplier or the client or the scope of activity of the user.

The electronic commerce management server 10 is configured to execute:
(A1) a transaction process of executing process relating to the electronic commerce by the supplier and the client;
(A2) an approval process of approving electronic commerce; and
(A3) registration process of registering electronic commerce information of the approved electronic commerce in a plurality of databases in a distributed manner.

As the approval process, the electronic commerce management server 10 is configured to execute, as in the above embodiment, and to determine whether or not the electronic commerce is approved based on the result of the determination of the executed condition determination process. The approval process includes:
(A2-1) a transaction location acquisition process of acquiring supplier's location information at the time of approval and the client's location information at the time of approval when executing approval of the electronic commerce; and
(A2-2) a condition determination process having at least one of: a supplier determination process of comparing the acquired supplier's location information at the time of approval with the activity location and scope information of the user-related information of the supplier; and client determination process of comparing the acquired client's location information at the time of approval with the activity location and scope information of the user-related information of the client.

### [6.2] Modification 2

Next, the case of the approval process that continuously determines the authenticity of the supplier or the client and executes the approval process based on the result of the determination, as a second modification of the present embodiment.

### (Characteristics of Present Modification)

Instead of executing the approval process based on the location information of the supplier and the client acquired at the time of approval in the above embodiment, the present modification is characterized in that continuously determines the authenticity of the user who becomes the supplier or the client based on the location information of the user acquired at a given timing or at each predetermined timing, and that executes the approval process based on the result.

The approval server 30 of the present modification has a configuration for determining the authenticity of a user who can be a supplier or a client at a stage before executing electronic commerce based on the user location information acquired at a given timing or at each predetermined timing.

Specifically, the approval server 30:
(A1) executes a current location acquisition process for acquiring current location information indicating a current location of each user at a given timing or at each predetermined timing;
(A2) compares the acquired current location information with the registered activity location and scope information of the corresponding user and to determine authenticity of the scope of activity of each user;
(A3) rejects the approval of the electronic commerce when the user whose authenticity of the scope of activity is denied by determination process of the scope of the activity is at least one of the supplier and the client.

Based on this configuration, the approval server 30 of the present modification can continuously recognize the location of the activity and the scope of the activity of the supplier or the client at all times. Therefore, it is difficult to disguise the location of the activity or the scope of the activity of the client or the supplier and the time, and thus it is possible to realize a more fair trade, genuine, and highly reliable transaction in electronic commerce using a cryptographic asset.

### (Current Location Acquisition Process)

The location information management control unit 302 executes a current location acquisition process for acquiring current location information indicating the current location of the user at a given timing or at each predetermined timing.

For example, the location information management control unit 302 executes the current location acquisition process at a given timing such as a timing when the user registers for the electronic commerce service, a timing when the user uses the electronic commerce service for the first time, or a timing when the electronic commerce service provider requests the current location acquisition process.

The location information management control unit 302 executes the current location acquisition process at predetermined timing such as once a day, once a week, or every time the user logs in to the electronic commerce service.

The location information management control unit 302 acquires the current location information transmitted from the terminal device 20 of each user via the electronic commerce management server 10, and registers the acquired current location information in the user information storage unit 372 as historical information in association with each user.

The approval processing unit 303 may directly acquire the location information from the corresponding terminal device 20.

### (Scope of Activity Determination Process)

A location information management control unit 302 compares, for each user, the current location information of the user that has already been acquired (registered) and the activity location and scope information of the registered user at a given timing or at each predetermined timing, and executes an scope of the activity determination process for determining the authenticity of the scope of activity of each user.

Specifically, the location information management control unit 302 executes the scope of activity determination process at a given timing, for example, a timing when a predetermined number of pieces of current location information are stored or a timing when an inquiry for electronic commerce is generated.

The location information management control unit 302 executes the current location acquisition process at predetermined timing such as once a day, once a week, or every time the user logs in the electronic commerce service.

The location information management control unit 302 executes an scope of activity determination process for each user based on each past location of the activity of each user indicated by historical information already registered in the user information storage unit 372 and a location of activity for reference or a scope of activity for reference of each user.

When the location of the activity of the user in the historical information completely matches the location of activity for reference of the user, the location information management control unit 302 determines that the user is authentic.

Alternatively, when the location of the activity of the user in each historical information is within a predetermined scope (for example, within 100 m) from the location of activity for reference of the user, the location information management control unit 302 may determine that the user is genuine by assuming that the past activity location matches the registered location of activity for reference.

The location information management control unit 302 may determine that the user is genuine when the user's location of the activity in the historical information is within a predetermined scope of activity for reference such as within a predetermined scope (e.g., 10 km) from the same area or a predetermined point (a representative point of the area such as a point where a local government office is located).

### (Approval Process)

The approval processing unit 303 executes the approval process of approving a target of the electronic commerce when a user whose scope of the activity is found to be authentic by determination process of the scope of the activity is a supplier or a client, and of rejecting the approval of the target of the electronic commerce when the user whose scope of activity is denied to be authentic is at least one of the supplier or the client.

In addition to the above approval process, when the approval is not rejected by the approval process (that is, when the user whose the scope of the activity is recognized as authentic is the client, the supplier, or both), the approval processing unit 303 of the present modification executes the approval process based on the supplier's location information at the time of approval, the client's location information at the time of approval, or both of information, as in the above embodiment. Additionally, the approval processing unit 303 of the present modification may not execute the approval process based on the supplier's location information at the time of approval, the client's location information at the time of approval, or both information, and may succeed the approval as it is when the user whose scope of the activity is authentic is the client, the supplier, or both.

### [6.3] Modification 3

Next, a third modification of the present embodiment will be described in which the location information of the user is periodically acquired in the present embodiment or the above modification, the timing when the location information is acquired is identified, and the timing information indicating the timing is used for the approval process or the scope of activity determination processing.

### (Outline of Present Modification)

The approval server 30 of the present modification has a configuration in which, when acquiring the user's location information at a given timing or at each predetermined timing, the timing such as the date and time when the location information is acquired is identified, and the approval process is executed based on each location information including the identified timing.

### (Approval Process)

When the approval process of the supplier or the client is executed using a plurality of pieces of location information, the approval processing unit 303 determines whether or not there is a contradiction in the time-series location of the activity or scope of activity or time of the user of the supplier or the client.

For example, the approval processing unit 303: calculates a travel time from timing information associated with each the location of the activity and the location information indicating the next activity location; and determines whether or not there are any inconsistencies in travel time including the use of transportation such as an automobile, a train, or an airplane.

The approval processing unit 303 determines whether at least one of the calculated travel times is satisfied including the use of the transportation such as an automobile, a train, or an airplane.

At this time, the approval processing unit 303 executes the approval process of approving the electronic commerce when all of the calculated travel times are satisfied, on condition that other conditions are satisfied, and of rejecting the approval of the electronic commerce when at least one of the calculated travel times is not satisfied.

### (Scope of Activity Determination Process)

When the authenticity of the user is determined using a plurality of pieces of location information, the location information management control unit 302 may use timing information indicating the timing when each piece of location information is acquired, as in the approval process of the approval processing unit 303.

For example, the location information management control unit 302 calculates, similar to the approval processing unit 303, a travel time from timing information associated with information indicating each of the location of the activity and the next location of the activity; and determines whether or not there are any inconsistencies in travel time including the use of transportation such as an automobile, a train, or an airplane.

The approval processing unit 303 determines whether at least one of the calculated travel times is satisfied including the use of transportation such as an automobile, a train, or an airplane.

At this time, the location information management control unit 302 executes the determination process of the scope of activity for determining that the corresponding user is authentic on the condition that other conditions are satisfied when there are not any inconsistencies in all of the travel times, and for determining that the corresponding user is not authentic when there is inconsistency in at least one of the calculated travel times.

### [6.4] Modification 4

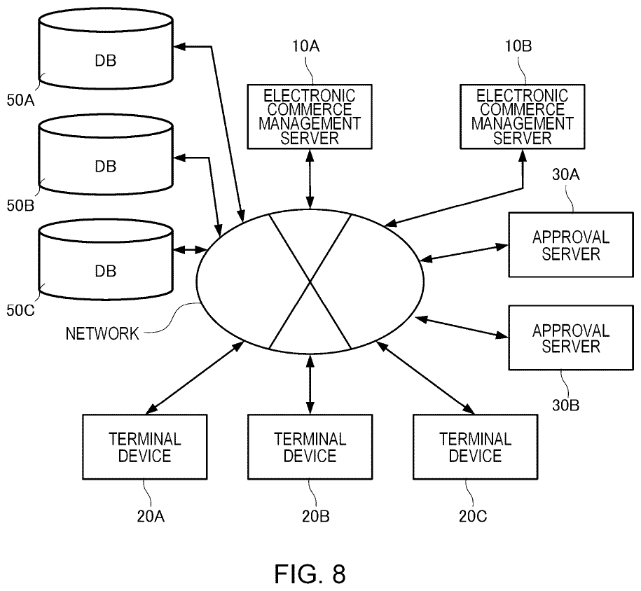

Next, an electronic commerce system S is configured by a plurality of servers according to a fourth modification of the present embodiment will be described with reference to FIG. 8.

FIG. 8 is a system configuration of an electronic commerce system S in a fourth modification of the embodiment.

In the above embodiment or the above modification, the electronic commerce system S may be constituted by a plurality of electronic commerce management servers 10 or a plurality of approval servers 30.

In other words, when the electronic commerce system S is configured by the plurality of electronic commerce management servers 10, the electronic commerce system S has an electronic commerce management server 10A for executing the process relating to supplier with the terminal device 20A of the supplier, and an approval server 30 for executing the process relating to the client with terminal device 20B of the client, as shown in FIG. 8.

The electronic commerce management server 10A and the electronic commerce management server 10B establish a communication line through the network N and perform various processes in conjunction with each other to perform various processes related to the electronic commerce.

When the electronic commerce system S is configured by a plurality of approval server 30, the electronic commerce system S has an approval server 30A for performing approval process for the supplier in conjunction with an electronic commerce management server 10A for executing the process relating to the supplier, and an approval server 30B for performing approval process for the client in conjunction with an electronic commerce management server 10B for executing the process relating to the client, as shown in FIG. 8.

### [6.5] Modification 5

Next, the electronic commerce system S configured by a plurality of servers according to a fifth modification of the present embodiment will be described.

In the above embodiment, the electronic commerce information is distributed and registered in a plurality of the databases 50 by the electronic commerce management server 10 but may be registered in the user information storage unit 372 by the approval server 30.

Specifically, the approval server 30 of this modification may register information such as the type of funds or products, distribution channels including past suppliers and clients, past transaction dates or dates and times, past transaction volumes, and past transaction amounts in the user information storage unit 372 each time a transaction is executed as electronic commerce information.

### [7] Other

The present embodiment is not limited to those in the above-described embodiments, and various modifications and variations can be made. For example, words cited as broadly or synonymously in the description or drawings may be replaced by broadly or synonymously in the description or drawings.

The present embodiment includes substantially the same configuration as the configuration described in the embodiment (for example, configuration with the same function, method and result, or configuration with the same purpose and effect). The present embodiment also includes a configuration in which non-essential parts of the configuration described in the embodiment are replaced. The present embodiment also includes a configuration that achieves the same effects as the configuration described in the embodiment or a configuration that can achieve the same purpose. The embodiment also includes a configuration obtained by adding a known technique to the configuration described in the above embodiment.

Although the present embodiments have been described in detail as described above, it will be readily apparent to those skilled in the art that many variations are possible without departing materially from the new matter and effect of the present invention. Accordingly, all such modifications are intended to be within the scope of the present invention.

### REFERENCE SIGNS LIST

S Electronic Commerce System
10 Electronic Commerce Management Server
20 Terminal Device
30 Approval Server
40 GPS Satellite
50 Databases
100 Processing Unit
101 Communication Control Unit
102 Electronic Commerce Management Control Unit
103 User Information Management Control Unit
110 Timer Management Unit
170 Storage Unit
171 Main Storage Unit
172 User Information Storage Unit
180 Information Storage Medium
196 Communication Unit
300 Processing Unit
301 Communication control Unit
302 Location Information Management Control Unit
303 Approval Processing Unit
310 Timer Management Unit
311 Information Providing Unit
370 Storage Unit
371 Main Storage Unit
372 User Information Storage Unit
380 Information Storage Medium
396 Communication Unit

1. An electronic commerce approval system for approving a given electronic commerce based on a crypto-asset when the electronic commerce is executed by a supplier and a client, the system comprising one or more processors and one or more memories, the processor programmed to:
manage activity location and scope information which is information registered in advance in a storage unit and which indicates a location or scope of an activity, serving as a reference for an activity of each user who is a supplier or a client;
identify a transaction target person based on transaction target person information relating to at least one of the supplier and the client, the transaction target person information being transmitted from a server when the electronic commerce between the supplier and the client is executed by the server;
execute an approval process of approving the electronic commerce between the identified supplier and the client;
provide the result of the approval process to the server, wherein
the processor programmed to perform the approval process including:
a transaction location acquisition process of acquiring location information for transaction target person at the time of approval indicating current location information of the transaction target person when the approval of the electronic commerce is executed; and
a condition determination process: of comparing the acquired location information for transaction target person at the time of approval with the registered activity location and scope information for the user who is the transaction target person; and of determining whether the result of comparison satisfies a given condition, and
determine whether the electronic commerce is approved based on a result of the condition determination process.

2. The electronic commerce approval system according to claim 1, wherein:
the processor programmed to:
acquire current location information indicating a current location of the user at a given timing or at each predetermined timing; and register the acquired current location information in the storage unit as historical information of an activity location and scope of the user, and
execute, as the approval process, the condition determination process based on: at least one of the acquired location information of the transaction target user at the time of approval and historical information of the transaction target user already registered; and the registered activity location and scope information of the transaction target user.

3. The electronic commerce approval system according to claim 1, wherein:
the processor programmed to:
acquire the current location information indicating a current location of the user at a given timing or at each predetermined timing;
execute a determination process of the scope of activity for determining authenticity of the scope of activity of the user by comparing the acquired current location information and activity location and scope information registered the activity location and scope information of the corresponding user; and
reject, as the approval process, the approval of a target electronic commerce when the user whose authenticity of the scope of the activity is denied by the determination process of the scope of activity is at least one of the supplier and the client.

4. The electronic commerce approval system according to claim 2, wherein:
the current location information includes timing information indicating a timing when the current location information is acquired.

5. The electronic commerce approval system according to claim 1, wherein
the server registers the information relating to the electronic commerce as electronic commerce information in a plurality of databases in a distributed manner, and
the electronic commerce information is formed by block information which is blocked based on a plurality of pieces of commercial transaction information including the commercial transaction information and a hash value determined from past commercial transaction information when the electronic commerce is approved.

6. An approval method of electronic commerce for approving a given electronic commerce based on a crypto-asset by a computer when the electronic commerce is executed by a supplier and a client, the approval method comprising:
managing activity location and scope information which is information registered in advance in a storage unit and which indicates a location or scope of an activity, serving as a reference for an activity of each user who is a supplier or a client;
identifying a transaction target person based on transaction target person information relating to at least one of the supplier and the client, the transaction target person information being transmitted from a server when the electronic commerce between the supplier and the client is executed by the server;
executing an approval process of approving the electronic commerce between the identified supplier and the client;
providing the result of the approval process to the server, wherein
the approval process includes:
a transaction location acquisition process of acquiring location information for transaction target person at the time of approval indicating current location information of the transaction target person when the approval of the electronic commerce is executed; and
a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.

7. An electronic commerce management system for managing an electronic commerce when the electronic commerce is executed by a supplier and a client based on a crypto-asset, the electronic commerce management system comprising one or more processors and one or more memories, the processor programmed to:
manage user-related information that indicates information relates the user and is registered in advance in a storage unit, the user-related information including activity location and scope information that indicates information of a location or scope of an activity, serving as a reference for an activity of user who is a transaction target of at least one of the supplier and the client;
execute, as transaction process, process relating to the electronic commerce by the supplier and the client;
execute an approval process of approving the electronic commerce; and
register the electronic commerce information of the approved electronic commerce in a plurality of databases in a distributed manner, wherein
the processor programmed to perform the approval process including:
a transaction location acquisition process of acquiring location information for transaction target person at the time of approval indicating current location information of the transaction target person when the approval of the electronic commerce is executed; and
a condition determination process: of comparing the acquired location information for transaction target person at the time of approval with the registered activity location and scope information for the user who is the transaction target person; and of determining whether the result of comparison satisfies a given condition, and
determine whether the electronic commerce is approved based on a result of the condition determination process.

8. A method of electronic commerce for executing a given electronic commerce when the electronic commerce is executed by a supplier and a client based on a crypto-asset by a computer, the method comprising:
managing user-related information that indicates information relates the user and is registered in advance in a storage unit, the user-related information including activity location and scope information that indicates information of a location or scope of an activity, serving as a reference for an activity of user who is a transaction target of at least one of the supplier and the client;
executing, as transaction process, process relating to the electronic commerce by the supplier and the client;
executing an approval process of approving the electronic commerce; and
registering the electronic commerce information of the approved electronic commerce in a plurality of databases in a distributed manner, wherein
the approval process includes:
a transaction location acquisition process of acquiring location information for transaction target person at the time of approval indicating current location information of the transaction target person when the approval of the electronic commerce is executed; and
a condition determination process: of comparing the acquired location information for transaction target person at the time of approval with the registered activity location and scope information for the user who is the transaction target person; and of determining whether the result of comparison satisfies a given condition, and
determines whether the electronic commerce is approved based on a result of the condition determination process.
